(19) United States
(12) Patent Application Publication
(10) Pub. No.: US 2018/0318869 A1
(43) Pub. Date: Nov. 8, 2018

(54) PIVOTING APPLICATOR ASSEMBLY FOR SEALANTS AND ADHESIVES

(71) Applicant: James W. Jensen, St. George, UT (US)

(72) Inventor: James W. Jensen, St. George, UT (US)

(21) Appl. No.: 15/969,592

(22) Filed: May 2, 2018

Related U.S. Application Data
(60) Provisional application No. 62/500,087, filed on May 2, 2017.

(51) Int. Cl. B05C 17/005

(52) U.S. Cl. CPC B05C 17/00503

(57) ABSTRACT

A pivoting applicator assembly has a base member and a pivoting member, wherein the base member is coupled to an applicator tube (e.g., caulk tube) and wherein the pivoting member is coupled to the end of the base member and is configured to pivot thereon.

### CROSS-REFERENCE TO RELATED APPLICATIONS

This application claims the benefit of U.S. Provisional Application Ser. No. 62/500,087, filed on May 2, 2017, which is incorporated herein by reference in its entirety.

### TECHNICAL FIELD

The present disclosure relates to systems and methods of applying sealants (e.g., caulk) and adhesives to surfaces. More particularly, the present disclosure relates to an applicator for coupling to a sealant or adhesive dispensing unit (e.g., caulk gun).

### BACKGROUND

Sealant dispensing units, such as caulk guns, have been in wide use for many years. The benefits of such a unit is the ability to quickly and easily dispense a large amount of needed material. However, because of this ability, too much product is often dispensed, requiring additional clean up by a user. Further, the product may not distribute evenly, which may not leave a good aesthetic appearance. When this occurs, the user must use another device or a finger to attempt to evenly distribute the caulk. This leads to decreased productivity of a user, which can increase costs. It can also lead to considerable waste of the product, which unnecessarily increases cost.

Further, dispensing units typically have a straight tip leading from the tube. This can make applying product in tight or angled spaces very difficult. Users have attempted to cut the tip at varying angles to attempt to solve this problem, but an angled tip restricts the use of the applicator to that specific angle, which may not be desirable in other circumstances.

As such, there remains a need for an apparatus that can aid a user in applying consistent product to a surface, that creates an aesthetically pleasing look, that allows a user to apply product at varying angles, and that saves on cost. The present disclosure seeks to solve these and other problems.

### SUMMARY OF EXAMPLE EMBODIMENTS

In one embodiment, a pivoting applicator assembly comprises a base member and a pivoting member, wherein the base member is coupled to an applicator tube (e.g., caulk tube) and wherein the pivoting member is coupled to the end of the base member and is configured to pivot thereon.

In one embodiment, an applicator tube comprises a working end configured to receive a pivoting member, wherein the pivoting member is configured to pivot thereon.

### BRIEF DESCRIPTION OF THE DRAWINGS

FIG. 1 illustrates a perspective view of a base member of a pivoting applicator assembly;

FIG. 2 illustrates a rear perspective view of a base member of a pivoting applicator assembly;

FIG. 3 illustrates a side elevation cross-section of a base member of a pivoting applicator assembly;

FIG. 4 illustrates a perspective view of a base member of a pivoting applicator assembly;

FIG. 5 illustrates a rear perspective view of a base member of a pivoting applicator assembly;

FIG. 6 illustrates a side elevation cross-section of a base member of a pivoting applicator assembly;

FIG. 7 illustrates a perspective view of a pivoting member of a pivoting applicator assembly;

FIG. 8 illustrates a rear plan view of a pivoting member of a pivoting applicator assembly;

FIG. 9 illustrates front perspective view of a pivoting member of a pivoting applicator assembly;

FIG. 10 illustrates an exploded perspective view of a pivoting applicator assembly;

FIG. 11 illustrates an assembled perspective view of a pivoting applicator assembly;

FIG. 12 illustrates a side elevation view of a pivoting applicator assembly assembled;

FIG. 13 illustrates a side elevation view of a pivoting applicator assembly with the pivoting member in a pivoted position;

FIG. 14 is a perspective view of a pivoting applicator assembly in use with a caulk gun; and

FIG. 15 is a perspective view of a pivoting applicator assembly wherein the caulk gun and the base member are of one manufacture.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for an apparatus that can aid a user in applying consistent product to a surface, that creates an aesthetically pleasing look, that allows a user to apply product at varying angles, and that saves on cost. The pivoting applicator assembly shown and described herein solve these needs and others.

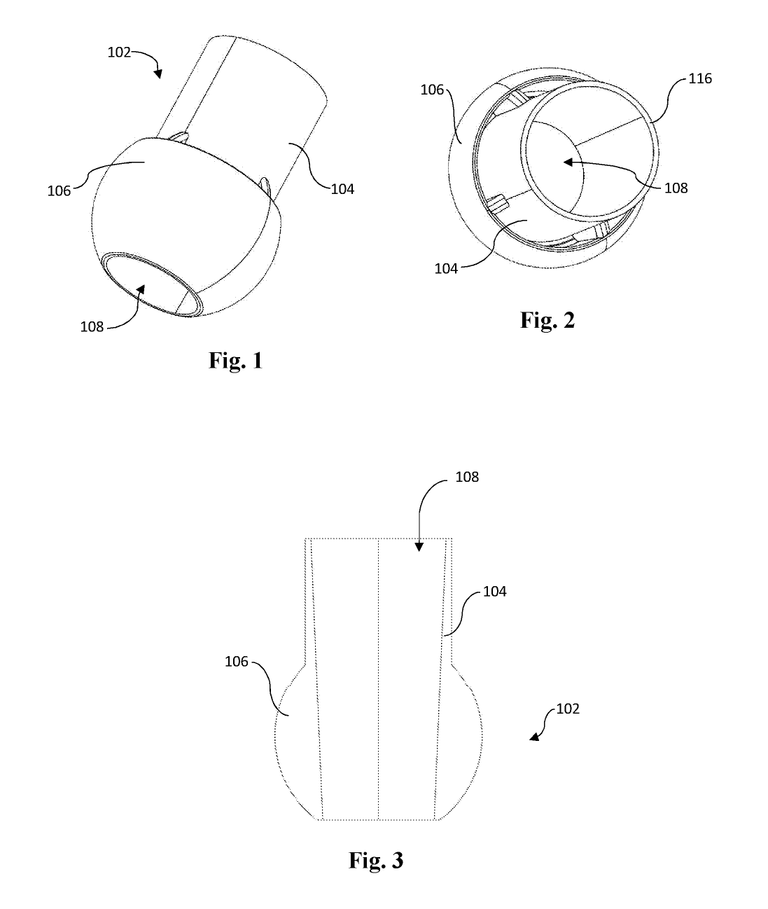

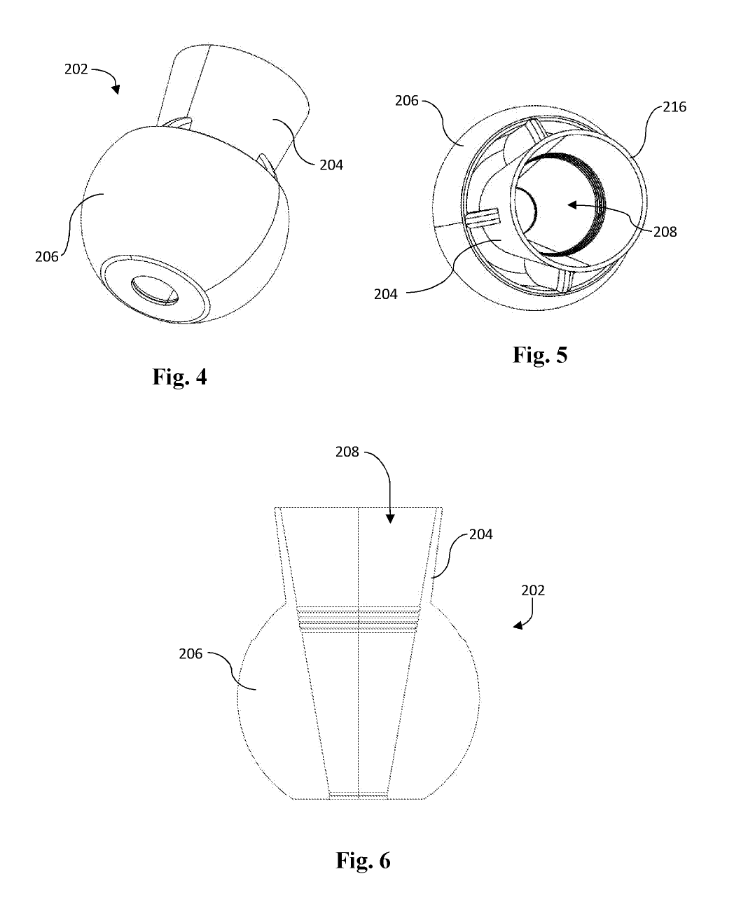

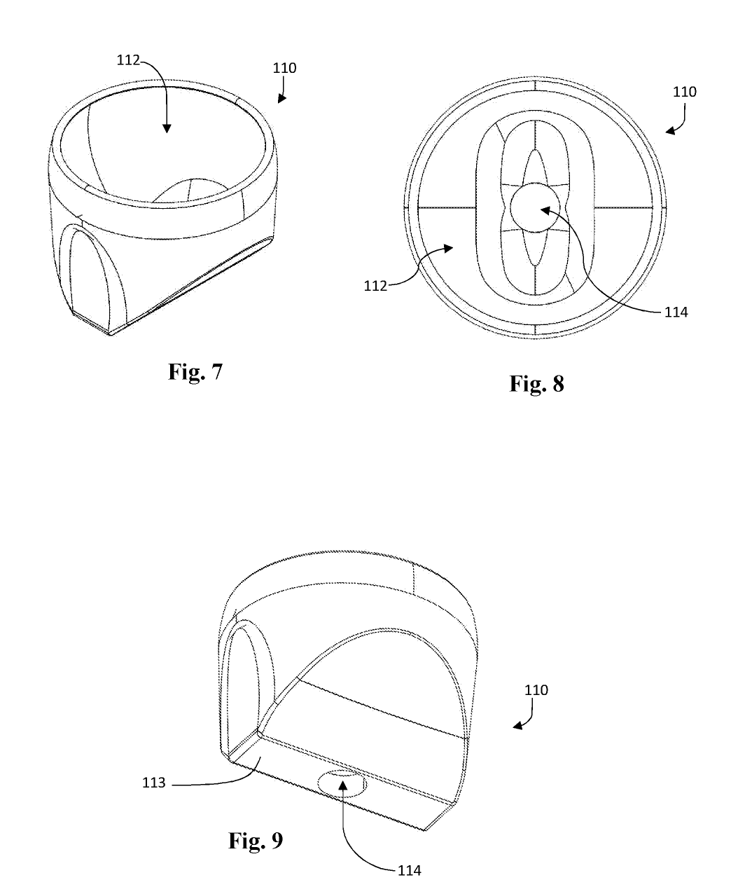

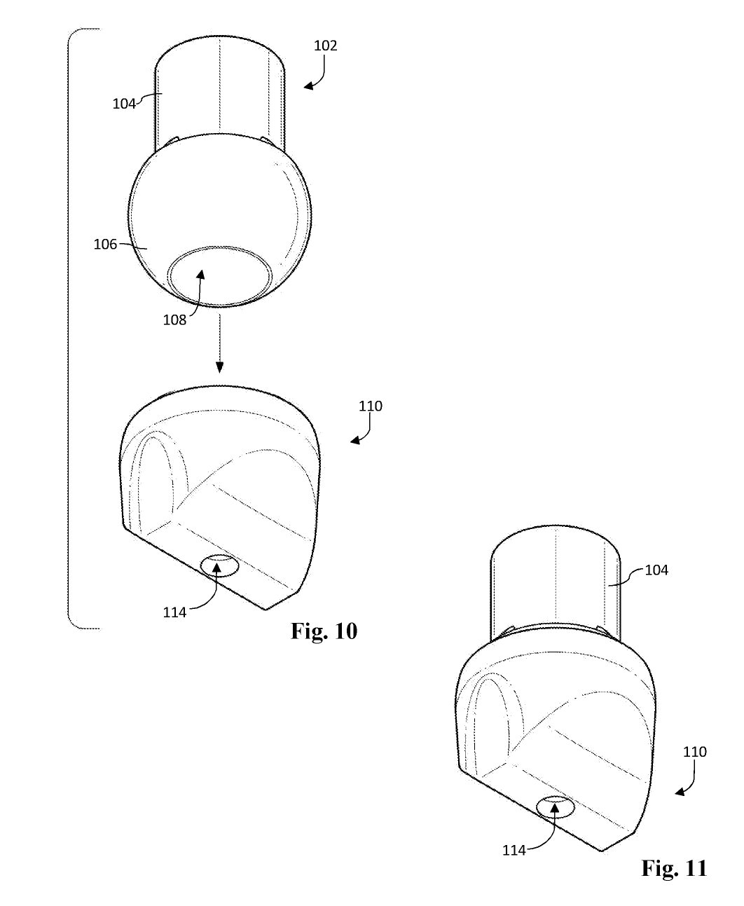

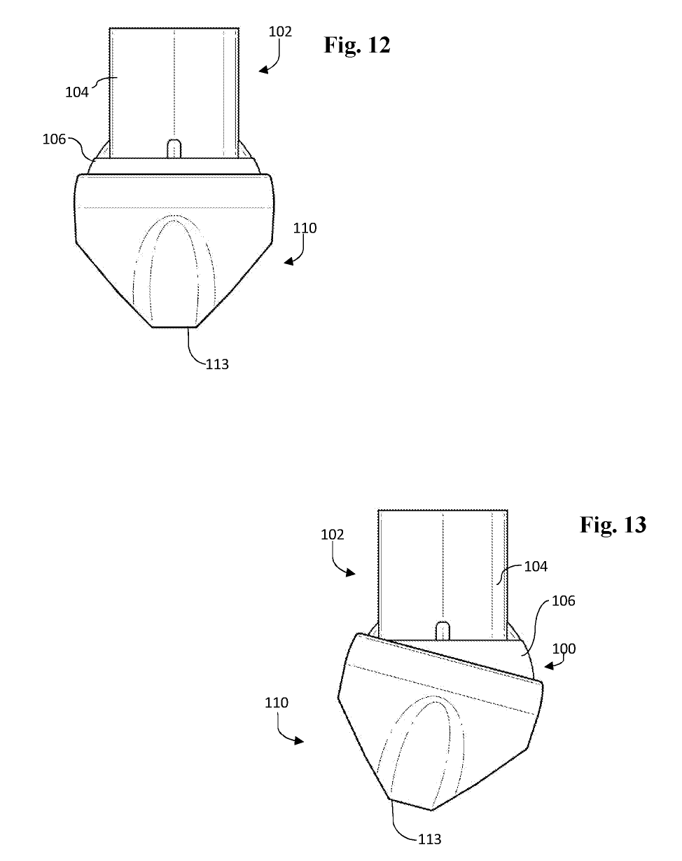

In one embodiment, as shown in FIG. 1-3 a pivoting applicator assembly comprises a base member 102 having a neck portion 104, a spherical portion 106, and a channel 108 running therethrough. The base member 102 may have varying configurations. For example, as shown in FIGS. 4-6, base member 202 comprises a neck portion 204, a spherical portion 206, and a channel 208 running therethrough. As shown, channel 208 is configured as a funnel, allowing the user to be more precise when dispensing product therethrough. In other words, the channel 208 is wider at the neck 204 than in the spherical portion 206. This restricts the amount of product that flows out of the spherical portion 206. FIGS. 7-9 illustrate a pivoting member 110. The pivoting member 110 comprises a spherical aperture 112 and a product dispensing aperture 114. The spherical aperture 112 is complementary to the spherical portion 106 of the base member 102. FIGS. 10-11 illustrate how the base member 102 is coupled to the pivoting member 110. Because the receiving aperture 112 is complementary to the spherical portion 106, the pivoting member 110 is able to both pivot and rotate thereon (i.e., ball and socket joint). In one embodiment, the pivoting member 110 is made from sufficiently flexible material (e.g., plastic) so as to fit over the spherical portion 106 with applied force, as seen in FIGS. 10-11. Accordingly, the pivoting member 110 may be coupled to, and removed from, the base member 102 as desired by a user. Such assembly makes cleanup and replacement easy and cost effective. It will be appreciated that other methods and materials may be used to allow the flexion and/or removable attachment of the pivoting member 110 to the base member 102. For example, flexible plastics, rubbers, tongues and grooves, protrusions, or other means or materials may be used to achieve the ball-socket result. The ball-and-socket configuration allows the pivoting member to rotate and pivot, as shown best in FIG. 13. This allows a user to more easily place product in cracks and crevices without the product-dispensing tube being at the same angle. This is particularly beneficial when a wall, faucet, or other object prevents the product-dispensing tube from achieving the correct angle. By utilizing the pivoting applicator assembly described herein, the pivoting member 110 pivots, overcoming those problems. Further, although the front edge 113 of the pivoting member 110 is illustrated as flat, any number of configurations are possible, accommodating the job at-hand. Regardless of configuration, uniformity in application persists as a result of using the pivoting member 110.

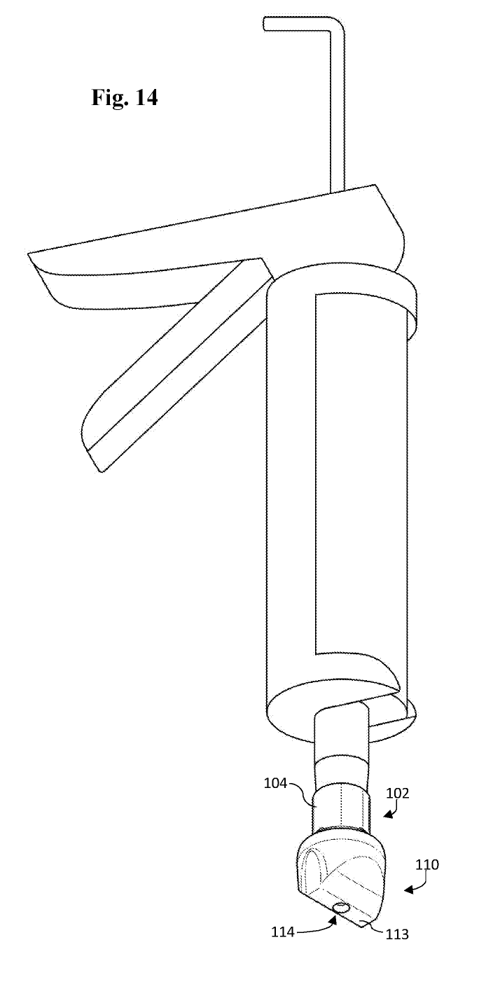

As further shown in FIG. 3, a product receiving aperture 116 (the channel opening on the neck portion) allows a user to insert any number of products therein. For example, as shown in FIG. 14, the product dispensing tip of a caulk tube may be inserted into the product receiving aperture 116. It will be appreciated that other products may be used, such as other sealants or adhesives, or other products that are dispensed from a tube. As understood, product would flow through the product receiving aperture 116 (or through the product dispensing tip within receiving aperture 116) through the channel 108, where it will then enter the pivoting member 102 and exit through the product dispensing aperture 114. As shown, and as will be appreciated, the dispensing aperture 114 can be located at various positions, depending upon the configuration of the pivoting member 110 in relation to the base member 102. This allows the worker to maneuver the applicator assembly as needed, such as to fit varying angles and surfaces. Further, the pivoting member 110 produces a uniform seal due to the shape of the pivoting member 110. Normally a worker would need to follow a bead of caulk with a finger or other item to smooth the bead and make it look uniform. However, the pivoting applicator assembly creates the uniform bead while dispensing product. This helps to save on product, while creating uniformity and aesthetically pleasing seals.

It will be appreciated that the pivoting applicator assembly described herein may be manufactured from a variety of materials, including plastics, rubbers, carbon fibers, and others.

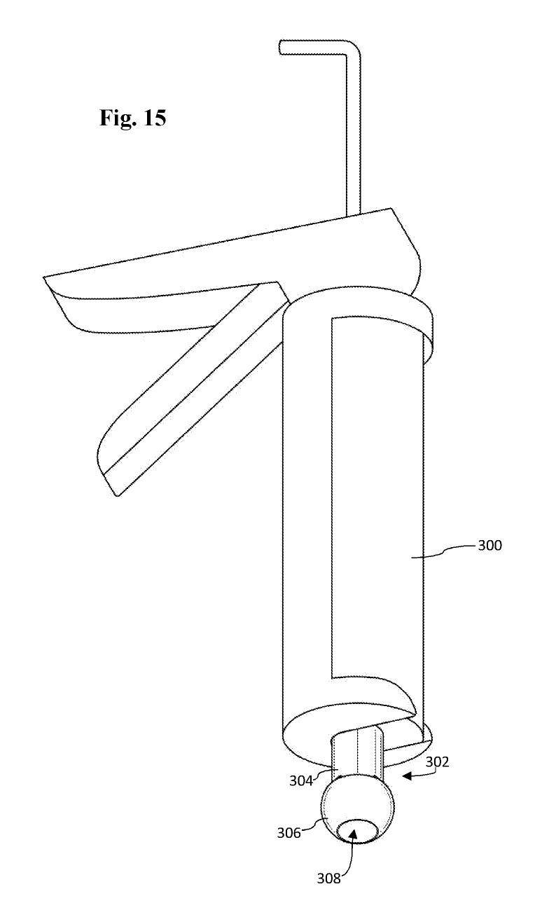

Further, a manufacturer may desire to manufacture the base member directly into the dispensing tip of the product, as shown in FIG. 15. As shown, a caulk tube 300 comprises a a neck 304, a spherical member 306, and a dispensing channel 308. A pivoting member may then be coupled thereto. Further, in one embodiment, the pivoting member need not be removable from the spherical member 306.

It is appreciated from the foregoing that the pivoting applicator assembly described herein solves the need for an apparatus that can aid a user in applying consistent product to a surface, that creates an aesthetically pleasing look, that allows a user to apply product at varying angles, and that saves on cost.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A pivoting applicator assembly, comprising:
a base member comprising a neck portion, a spherical portion, and a channel running through the neck and spherical portions; and
a pivoting member comprising a spherical aperture complementary to the spherical portion of the base member, and a product dispensing aperture;
wherein the pivoting member couples to, and pivots on, the base member.

2. The pivoting applicator assembly of claim 1, wherein the channel is of uniform diameter.

3. The pivoting applicator assembly of claim 1, wherein the channel is a funnel.

4. A pivoting applicator assembly, comprising:
a caulk tube comprising a neck and a spherical portion; and
a pivoting member for coupling to the spherical portion of the caulk tube.
